(19) United States
(12) Patent Application Publication
(10) Pub. No.: US 2026/0177091 A1
(43) Pub. Date: Jun. 25, 2026

(54) JOINT ARRANGEMENT AND METHOD FOR CONNECTING MAIN GIRDER PARTS

(71) Applicant: KONECRANES GLOBAL CORPORATION, Hyvinkää (FI)

(72) Inventors: Tero AALTONEN, Hyvinkää (FI); Kari SIITARI, Hyvinkää (FI); Timi HONKANEN, Hyvinkää (FI)

(21) Appl. No.: 19/128,827

(22) PCT Filed: Nov. 9, 2023
(86) PCT No.: PCT/FI2023/050621

§ 371 Date: May 9, 2025

(30) Foreign Application Priority Data
Nov. 10, 2022 (FI) 20226013

(51) Int. Cl. F16B 5/02; B66C 6/00

(52) U.S. Cl. CPC F16B 5/02; B66C 6/00

(57) ABSTRACT

A joint arrangement and method for connecting main girder parts, which comprises a first plurality of finger elements arranged on a first main girder part, a second plurality of finger elements arranged on a second main girder part, each finger element, of the first plurality and the second plurality of finger elements comprises a top surface a bottom surface, a first end and a second end wherein the first plurality of finger elements and the second plurality of finger elements are arranged to interconnect with each other, and a first fastener arranged to rigidly lock the first plurality and the second plurality of finger elements together.

### TECHNICAL FIELD

The present invention relates to a joint arrangement and more precisely to a joint arrangement and a method for connecting two main girder parts of a crane.

### BACKGROUND

Cranes, used for example inside an industry hall or for lifting containers at ports, typically comprises at least one long main girder for supporting a hoist. The main girder is divided to at least two main girder parts for easier and convenient transport from a crane manufacturer to a crane user. The main girder parts are then connected to each other at the crane user's facility.

The longitudinal main girder parts are connected to each other by their ends and both parts have a central web comprising at least one web plate, a longitudinal upper flange or top plate arranged to the top part of the central web as well as a longitudinal lower flange which is arranged to the bottom part of the central web, and which protrudes from the central web to its sides.

Conventionally, joining the main girder parts has been implemented by welding together the main girder parts at the ends facing each other, or as a flange joint or a strapped joint of these ends.

In the flange joint, sturdy transverse end plates and bolts are used to join the ends of the main girder parts. To ensure the functioning of the bolts in such a joint, the thickness of the flanges is typically large and additional welding is required for a strong joint. However, welding the end plates profile-like or casing-like main girder parts causes a large local heat input which may result in deformations that have to be compensated for by machining.

In the strapped joint, junction plates are fixed on both sides of the central webs of the main girder parts as well as to the lower and upper flanges. Bolts are used both in the webs to convey shear force, and in the flanges to convey bending moment. This solution has plenty of bolts and holes to align, which is a demanding procedure.

In both solutions, the number of joining elements is often high, which is both time and material consuming.

### BRIEF DESCRIPTION

An object of the present invention is to solve the above-mentioned drawbacks and to provide a new type of joint arrangement and a method for connecting main girder parts.

This and other objects are achieved with the joint arrangement and the method according to independent claims. Preferred embodiments are disclosed in dependent claims.

The joint arrangement is based on the idea of a first plurality of finger elements arranged on a first main girder part, and a second plurality of finger elements arranged on a second main girder part, wherein the first plurality of finger elements and the second plurality of finger elements are arranged to interconnect with each other, and a first fastener arranged to rigidly lock the finger elements together.

One of the advantages obtained from this invention is using fewer joining elements while achieving sufficient support and friction capacity. Due to this, the joint arrangement can be placed and hidden inside the main girder so there will be no or minimized impact to the outer dimensions of the main girder. The joint arrangement can also be placed outside the main girder, for example on top of the upper flange, which will provide easier checking and maintenance.

### BRIEF DESCRIPTION OF THE DRAWINGS

In the following the invention will be described in greater detail by means of preferred embodiments with reference to the attached drawings, in which

FIG. 1 illustrates a perspective view of a joint arrangement according to an embodiment;

FIG. 2 illustrates an exploded view of the joint arrangement of FIG. 1;

FIG. 3 illustrates a closer view of a finger element according to an embodiment;

FIG. 4 illustrates a perspective view of a joint arrangement according to another embodiment;

FIG. 5 illustrates another perspective view of the joint arrangement according to the embodiment, where the joint arrangement is not fully attached to the main girder part;

FIG. 6 illustrates a side view of the joint arrangement assembled to the main girder part;

FIG. 7 illustrates a flow chart of a method for connecting two main girder parts.

### DETAILED DESCRIPTION

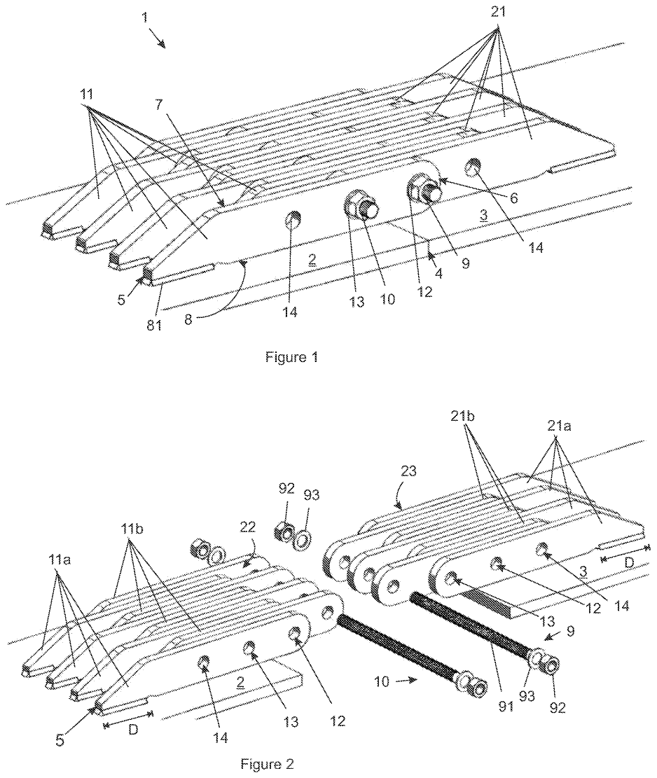

The present invention pertains to a joint arrangement 1 for connecting two main girder parts 2, 3 of a crane where they are to be joined together by their ends which defines a joint 4. FIG. 1 illustrates a perspective view of the joint arrangement 1 according to an embodiment where the joint arrangement is attached to the main girder parts 2, 3 and fastened together, and FIG. 2 illustrates an exploded view of the joint arrangement 1 of FIG. 1.

The main girder part 2, 3 can be a beam or a central web comprising at least one web plate, a longitudinal upper flange or top plate arranged to the top part of the central web, and a longitudinal lower flange which is arranged to the bottom part of the central web, which protrudes from the central web to its sides. Referring to the Figures, the main girder parts 2, 3 are shown as simplified plates on which the joint arrangement 1 is arranged. These plates may correspond to any of the upper flange or the lower flange or the web plate of the central web or the beam.

The joint arrangement 1 is arranged on the joint 4 where the first main girder part 2 and the second main girder part 3 are to be connected. The joint arrangement 1 comprises a first plurality of finger elements 11 arranged on a first main girder part 2, and a second plurality of finger elements 21 arranged on a second main girder part 3. When joined together, the finger elements 11, 21 are arranged in such a way that the first plurality of finger elements 11 and the second plurality of finger elements 21 are interconnected with each other. The term “interconnect” in this context refers to arranging the finger elements with each other by alternating the finger elements of the first plurality of finger elements 11 and the finger elements of the second plurality of finger elements 21 so that every other finger element of the joint arrangement 1 is associated with the first plurality of finger elements 11. The finger element is preferably made of metal, such as structural steel.

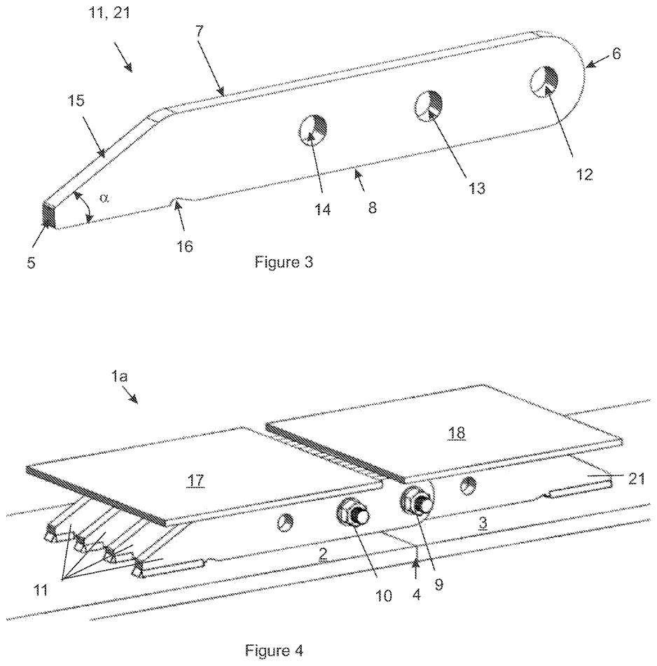

Referring to FIG. 3, which shows a closer view of the finger element according to an embodiment. Each finger element of the first plurality 11 and the second plurality of finger elements 21 comprises a top surface 7, a bottom surface 8, a first end 5 and a second end 6. The bottom surface 8 in this context refers to the surface contacting at least one of the first or second main girder part 2, 3 and the top surface 7 refers to the surface facing away from the first or second main girder parts 2, 3. The first end 5 in this context refers to the end directed away from the joint 4 and second end 6 refers to the end opposite the first end 5.

At least one finger element of the first plurality of finger elements 11 may comprise at least one friction surface 22 arranged to contact with a friction surface 23 of the adjacent finger element of the second plurality of the finger elements 21. The friction surface 22, 23 in this context may refer to any side surface of the finger element which is substantially perpendicular to a surface of the first 2 or second main girder part 3 wherein the joint arrangement 1 is arranged to be attached to. A suitable thickness of the finger element of the first plurality of finger elements 11 or the second plurality of finger elements 21 or both may be 10-30 mm, for instance, and especially approximately 20 mm. However, other thicknesses may be applied or even vary between each finger elements 11, 21.

Each finger element of the first plurality 11 and the second plurality of finger elements 21 may be longitudinally parallel with each other. When interconnected together, the parallelism provides a friction capacity of the friction surface 22, 23 between the finger elements 11, 21. Each finger element of the first plurality 11 and the second plurality of finger elements 21 may also be at least partially over-lapping with each other.

In the embodiment illustrated in FIGS. 1 and 2, the first plurality of finger elements 11 includes one finger element more than the second plurality of finger elements 21. This alleviates lateral bending of the joint arrangement 1. In FIGS. 1 and 2, the first plurality of finger elements 11 contains eight finger elements, and the second plurality of finger elements 21 contains seven finger elements. Other number of finger elements of the first plurality of finger elements 11 may also be used, wherein the number of finger elements of the second plurality of finger elements 21 is one less.

Each finger element of the first plurality 11 and the second plurality of finger elements 21 may be substantially identical for simpler mass manufacturing process. However, in some embodiments, lengths of the finger element may vary depending on whether the finger element is odd number 11a or even number 11b of the first plurality of finger elements 11, or odd number 21a or even number 21b of the second plurality of finger elements 21. Odd numbers 11a, 21a of finger elements may be identical to each other, and even numbers 11b, 21b of finger elements may be identical to each other but longer or shorter compared to odd numbers 11a, 21a of finger elements.

As illustrated in FIGS. 1 and 2, the first ends 5 of odd numbers 11a of the finger element of the first plurality of finger elements 11 may be arranged longitudinally at a distance D away from first ends 5 of even numbers 11b of the finger elements of the first plurality of finger elements 11, or that odd numbers 21a of the finger element of the second plurality of finger elements 21 may be longitudinally at a distance D away from even numbers 21b of the finger elements of the second plurality of finger elements 21, or both. This way, every other first end 5 of the finger elements of the first plurality of finger elements 11 is closer to the joint 4 on the first main girder part 2, and every other first end 5 of the finger elements of the second plurality of finger elements 21 is closer to the joint 4 on the second main girder part 3.

Alternating the distance of the adjacent finger elements of the first plurality 11 or second plurality of finger elements 21 from the joint 4 achieves an advantage during connecting procedure of the finger elements to the main girder parts 2, 3. For instance, in a welding process, wherein at least partial of a bottom surface 8 of each finger of the first plurality 11 and the second plurality of finger elements 21 is arranged to be welded to the respective first main girder part 2 and the second main girder part 3. To reach the bottom surface 8 or bottom edges of the finger element with welding equipment, spaced finger elements provide a sufficient distance for a welder for producing a neat and secure weld joint 81 for at least partially along the bottom edges of the bottom surface 8. After welding the odd 11a or even number 11 b of finger elements of the first plurality of finger elements 11, the welder can then continue welding the remaining finger elements of the first plurality of finger elements 11 which are also spaced and at the distance D away from the first ends 5 of the previously welded finger elements for producing neat and secure weld joints 81 for the remaining finger elements.

A first fastener 9 is arranged to rigidly lock all the finger elements 11, 21 of the joint arrangement 1 together by tensioning the finger elements 11, 21 towards each other for obtaining increased friction grip. In the accompanying Figures, the first fastener 9 is shown as a threaded rod 91 and a nut 92 with a washer 93 on each end of said rod 91. However, other fastener solutions, such as a clamp, or a bolt and a nut with a washer, may be used to obtain similar tensioning of the finger elements. The first fastener 9 may be arranged to pass through the first apertures 12 of all the finger elements 11, 21 of the joint arrangement 1, or it may be arranged to clamp the finger elements 11, 21 of the joint arrangement 1 together without an aperture.

A second fastener 10 may be a similar fastener to the first fastener 9 and arranged to pass through second apertures 13 of all the finger elements of the joint arrangement 1. Alternatively, the second fastener may be a clamp arranged to press the finger elements of the joint arrangement 1 together. The second fastener 10 provides tighter and more secure fastening with improved friction capacity, and additionally preventing any finger element of the joint arrangement 1 to rotate around the longitudinal axis of the first fastener 9.

The joint arrangement 1 may also comprise more than two fasteners 9, 10. However, it is preferred that each finger element of the first plurality 11 and the second plurality of finger elements 21 is connected to each fastener so any gap between adjacent finger elements of the first plurality 11 or the second plurality of finger elements 21 can be avoided. The elongated fasteners 9, 10 which produce a frictional force between the finger elements may be mainly arranged transverse to the longitudinal axis of the main girder parts 2, 3 to be connected.

Each finger element 11, 21 of the first plurality 11 and the second plurality of finger elements 21 may comprise at least the first aperture 12 and the second aperture 13 for accommodating respective the first fastener 9 and the second fastener 10. A distance between the first aperture 12 and the second aperture 13 may be constant in each finger element 11, 21, allowing the first fastener 12 and the second fastener 13 to be fastened in parallel with each other. The first aperture 12 and the second aperture 13 may be located along a longitudinal centreline of each finger element 11, 21.

The finger element 11, 21 may further comprise a third aperture 14 at a distance away from the first aperture 12 or the second aperture 13. Said distance may have same length as the distance between the first aperture 12 and the second aperture 13, and located on a same line, specifically the centreline. The third aperture 14 allows the joint arrangement 1 to utilize identical finger elements 11, 21. The location of the first aperture 12, second aperture 13 and third aperture 14 may vary depending on whether it is an odd or even number and whether it is a finger element of the first plurality 11 or the second plurality of finger elements 21.

The finger element may comprise a bevel 15 at the first end 5 and a rounded end at the second end 6, as illustrated in the accompanying Figures, making the finger element talon shaped. A bevel angle a between the bottom surface 8 and bevel surface may vary from 15 degrees to 45 degrees, and especially from 25 degrees to 35 degrees. The bevel 15 is arranged to facilitate welding process by providing easier access for welding equipment to reach its target.

The rounded second end 6 is arranged to facilitate rotation of the finger element 11, 21 around a longitudinal axis of the first fastener 9 or the second fastener 10 through the first aperture 12 or the second aperture 13. The rounded second end 6 may be semicircle, wherein a radius of curvature between the curve to the first fastener 9 or the second fastener 10 may be constant.

The finger element 11, 21 may further comprise an indentation 16 at the bottom surface 8, said indentation 16 forming a through-hole with the first main girder part 2 or the second main girder part 3. The indentation 16 may be located at the distance D away from the first end 5, where first ends 5 of the even number 11b or odd number 11a of the first plurality of finger elements 11 or even number 21b or odd number 21a of the second plurality of finger elements 21 closer to the joint 4 may be arranged.

The finger elements 11, 21 may be attached to the main girder parts 2, 3 by welding, for example by fillet weld 81 for a T-joint. As shown in FIGS. 1 and 2, only partially of the bottom surface 8 of each finger element 11, 21 is welded to the main girder part 2, 3 to provide sufficient connection. The weld 81 may begin from the indentation 16 and proceed towards the first end 5, around the first end 5 and ending near the other side of the indentation 16, thus forming a U-shaped weld 81. However, in some embodiments, the weld 81 may be longer and begin closer to the joint 4.

The indentation 16 is arranged to at least partially accommodate the weld 81 of the adjacent finger element of the first plurality 11 or second plurality of finger elements 21 closer to the joint 4. The indentation 16 prevents uneven contact between the bottom surface 8 of the finger element 11, 21 and the surface of the main girder part 2, 3 due to the weld 81 of the adjacent finger element.

FIG. 4 illustrates a perspective view of a joint arrangement 1a according to another embodiment. The embodiment of FIG. 4 is very similar to the one explained in connection with FIG. 1. Therefore, the embodiment of FIG. 4 is in the following mainly explained by pointing out differences.

In this embodiment, at least one support plate 17, 18 is arranged on the top surface 7 of at least one finger element of the first plurality of finger elements 11 or on the top surface 7 of at least one finger element of the second plurality of finger elements 21 or both, parallel with the first main girder part 2 and second main girder part 3. As shown in FIG. 4, a first support plate 17 may be arranged on top of the first plurality of finger elements 11 and a second support plate 18 may be arranged on top of the second plurality of finger elements 21. The support plate 17, 18 can be made of same material as the finger elements 11, 21.

The support plate 17, 18 may be attached to the central web (not shown in Figures) by welding edges of the support plate 17, 18 contacting the central web. The support plate 17, 18 may alternatively be attached, by welding, to the top surfaces 7 of at least one finger element of the first plurality of finger elements 11 or to the top surface 7 of at least one finger element of the second plurality of finger elements 21. In some embodiments, the first support plate 17 may be attached to all the finger elements of the first plurality of finger elements 11, and the second support plate 18 may be attached to all finger elements of the second plurality of finger elements 21. The support plate 17, 18 adds more support and reduces bending of the bottom flange of the main girder part 2, 3.

In FIG. 4, the support plates 17, 18 are illustrated as rectangular plates. However, other shapes may be implemented to provide sufficient support for the joint arrangement 1a.

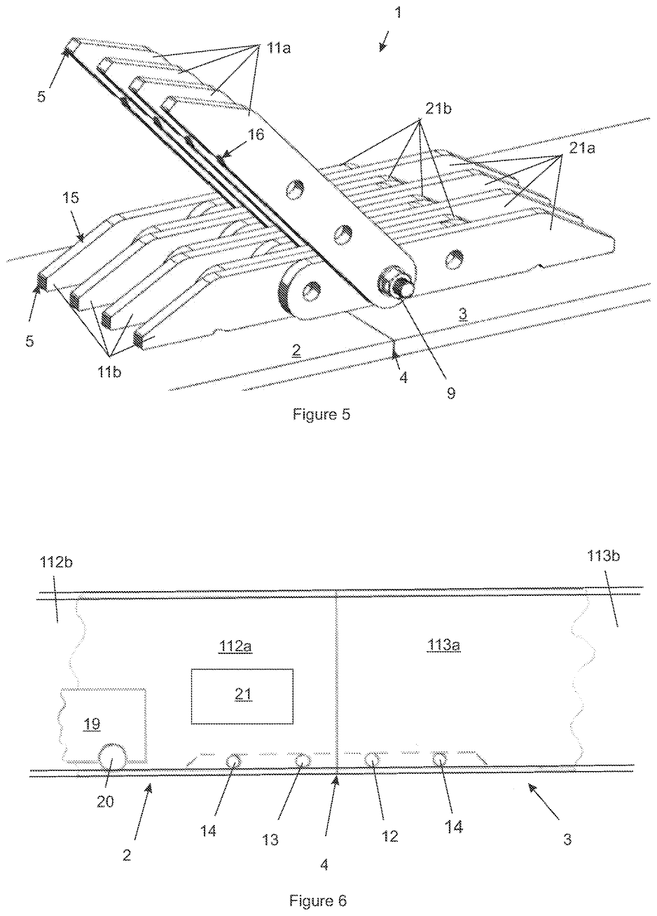

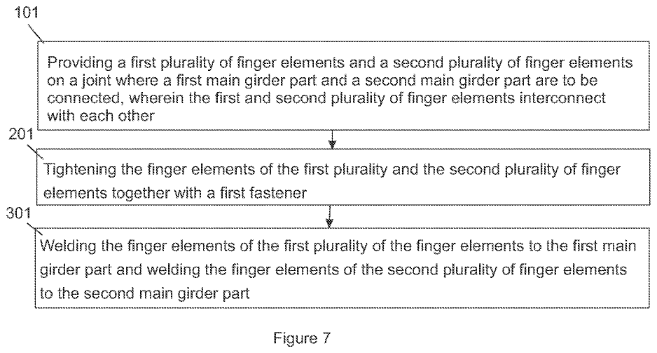

FIG. 5 illustrates another perspective view of the joint arrangement 1 according to the embodiment of FIG. 1, where the joint arrangement 1 is not fully attached to the main girder part 2, 3. This relates to the method of connecting two main girder parts 2, 3, and especially to step 302) which is described in more detail in context of FIG. 7.

In FIG. 5, odd fingers 11a of the first plurality of finger elements 11 have been rotated around the axis of the first fastener 9 and away from the even fingers 11b of the first plurality of finger elements 11 and the first main girder part 2. The first ends 5 of the odd fingers 11a are further away from the first ends 5 of the even fingers 11b in relation to the joint 4 or the first fastener 9.

This rotation can be similarly done to the second plurality of finger elements 21 on the second main girder part 3. The odd and even number may be ex-changed depending on which first ends 5 of the finger elements 11, 21 are further from the joint 4. In the accompanying Figures, odd number 11a, 21a of finger elements are further from the joint 4. However, in some embodiments, they could be even numbers 11b, 21b instead.

When every other rotated finger element 11, 21, whether they are odd or even, are no longer longitudinally side by side with the remaining finger elements, it and possible bevel 15 allows sufficient space for the welding equipment to weld the at least partially bottom surface 8 of the finger element to the main girder part 2, 3. After the finger elements 11, 21 having the first ends 5 arranged closer to the joint 4 are welded, the rotated finger elements 11, 21 can be rotated back to longitudinally side by side with the remaining finger elements, and become welded to the main girder part 2, 3.

FIG. 7 illustrates a flow chart of a method for connecting two main girder parts 2, 3. The method comprises:
101) providing a first plurality of finger elements 11 and a second plurality of finger elements 21 on a joint 4, where a first main girder part 2 and a second main girder part 3 are to be connected, each finger element 11, 21 of the first plurality and the second plurality of finger elements comprising a top surface 7, a bottom surface 8, a first end 5 and a second end 6, and interconnecting the first 11 and second plurality of finger elements 21 with each other.

In an embodiment, the method may further comprise 102) arranging first ends 5 of odd numbers 11a of the finger elements of the first plurality of finger elements 11 at a distance D away from first ends 5 of even numbers 11b of the finger elements of the first plurality of finger elements 11, and arranging first ends 5 of odd numbers 21a of the finger elements of the second plurality of finger elements 21 at the same distance D away from first ends 5 of even numbers 21b of the finger elements of the second plurality of finger elements 21.

The method further comprises 201) tightening the finger elements of the first plurality 11 and the second plurality of finger elements 21 together with a first fastener 9. In an embodiment, it can be implemented by for instance 202) securing all the finger elements 11, 21 together through a first aperture 12 of each finger elements 11, 21 with the first fastener 9, wherein the first aperture 12 is arranged on a longitudinal centreline of the finger element, and especially the first aperture 12 of the odd 11a or even numbers 11b of the first plurality of finger elements 11 having their first ends 5 arranged further from the joint 4 is located closest to the second end 6 of the first plurality of finger elements 11.

The method further comprises 301) welding each finger element 11 of the first plurality of the finger elements 11 to the first main girder part 2 and welding each finger element 21 of the second plurality of finger elements 21 to the second main girder part 3. In an embodiment, it can be implemented by for instance 302) rotating the even 11b or odd numbers 11a of the finger elements of the first plurality of finger elements 11 having their first ends 5 arranged further from the joint 4 before welding the odd 11a or even numbers 11b of the finger elements of the first plurality of finger elements 11 having their first ends 5 arranged closest to the joint 4 to the first main girder part 2, then rotating the even 11b or odd numbers 11a of the finger elements of the first plurality of finger elements 11 having their first ends 5 arranged further from the joint 4 back, and welding them to the first main girder part 2.

In an embodiment, said welding can be performed by only welding around the first end 5, and especially beginning from an indentation 16 and proceeding towards the first end 5, around the first end 5 and ending near the other side of the indentation 16, thus forming a U-shaped weld 81.

In an embodiment, the method may further comprise 401) tightening all finger elements of the first plurality 11 and the second plurality of finger elements 21 together with a second fastener 10 by securing the finger elements together through a second aperture 13 of each finger elements 11, 21 with said second fastener 10, wherein at least one of the second apertures 13 is located closest to the second end 6 of the second plurality of finger elements 21. Especially, wherein the second aperture 13 is located closest to the second end 6 of the odd 21a or even numbers 21 b of the finger elements of the plurality of finger elements 21 having their first ends 5 arranged further from the joint 4.

In an embodiment, the method may further comprise 501) releasing the first fastener 9 from each first aperture 12 of the finger elements 11, 21 while the second fastener 10 is fastened via each second aperture 13 of the finger elements 11,21.

In an embodiment, the method may further comprise 601) rotating the even 21b or odd numbers 21a of the finger elements of the second plurality of finger elements 21 further from the joint 4 before welding the odd 21a or even numbers 21b of the finger elements of the second plurality of finger elements 21 closest to the joint 4 to the second main girder part 3, then rotating the even 21b or odd numbers 21a of the finger elements of the second plurality of finger elements 21 further from the joint 4 back and welding them to the second main girder part 3.

In an embodiment, the method may further comprise 701) re-tightening the finger elements of the first plurality 11 and the second plurality of finger elements 21 together with the first fastener 9 by securing the finger elements 11, 21 together through the first aperture 12 of each finger elements 11, 21 with the first fastener 9, wherein at least one of the second apertures 13 is located closest to the second end 6 of the second plurality of finger elements 21.

Re-tightening may also be performed before welding the even 21b or odd numbers 21a of the finger elements of the second plurality of finger elements 21 having their first ends 5 arranged further from the joint 4 to the second main girder part 3.

In an embodiment, the method may further comprise 801) providing a first support plate 17 on top of the first plurality of finger elements 11, parallel with the first main girder part 2, and welding said first support plate 17 to the top surface 7 of at least one finger element of the first plurality of finger elements 11, or 802) providing a second support plate 18 on top of the second plurality of finger elements 21, parallel with the second main girder part 3, and welding said second support plate 18 to the top surface 7 of at least one finger element of the second plurality of finger elements 21, or both 801) and 802).

The present invention relates to a new type of joint arrangement 1 connecting two main girder parts 2, 3 or beams together using as few as one or two fasteners and multiple finger elements 11, 21 having friction surfaces. The main principle is to utilize said friction surfaces which are arranged to be tightened together to create more friction capacity and stronger joint while using fewer fastening parts, such as screws, bolts or rods, compared to conventional solutions. With the disclosed joint arrangement 1 and the method, a number of parts needed, material, manufacturing time and installation time can be saved while still creating a sturdy and safe connection between the main girder parts 2, 3.

FIG. 6 illustrates a side view of the joint arrangement 1 arranged inside the main girder parts 2, 3 according to an embodiment. The finger elements 11, 21 are connected to the bottom surface of the main girder parts 2, 3 and preferably inside the main girder parts 2, 3, so that they are inside of girder box between left webs 112a, 113a and right webs 112b, 113b. The first fastener 9 and the second fastener 10 are not shown in this Figure but they may be fastened to the joint arrangement 1 via the first aperture 12 and the second aperture 13, respectively. The joint arrangement 1 will not affect a trolley 19 traveling along the main girder parts 2, 3 wherein wheels 20 of the trolley 19 are adapted to run on the longitudinal lower flange of the main girder parts 2, 3. With the present joint 4, it is possible to decrease the gap of the joint 4 in the lower flange so small that the wheels 20 of the trolley 19 can cross it without a problem of unevenness of the gap.

The main girder parts 2, 3 may comprise an opening 21 for allowing a worker to check or loose or tighten the fasteners 9, 10 of the joint arrangement 1. The opening 21 can be large enough to allow a socket wrench, a torch, or a mirror inside the main girder parts 2, 3. The opening 21 can be normally covered with a cover when there is no need for accessing inside the main girder or main girder parts 2, 3.

One embodiment uses plurality of finger elements 11, 21, which are welded from their first ends 5 to the main girder parts 2, 3 and then fastened together with fasteners 9, 10. When the fasteners 9, 10 are tightened, the finger elements are compressed together creating several friction surfaces.

Another benefit obtained with the present invention is that the joint can be located inside of the main girder, so it is not affecting the outer dimensions. Conventional joints used in crane structures are partly outside of the main girder's cross section. This can lead to requirement of special or non-optimal cross-sections for the main girders with extension joints for the hoist to pass the joints.

The joint arrangement according to the present invention is preferably used in lower flanges of the main girder. Major part of the tension is transmitted via lower flange and the joint arrangement needs to be strong enough to safely transmit these forces. It is also beneficial for the joint arrangement to be located inside the casing of the main girder and not limiting movement of the hoist. However, same principle can also be used on upper flange when transmitting compression. In conventional joints, there can be hundreds of screws. Assembling these kinds of joints is time consuming and requires more material. The present invention is also easier to scale up to bigger and wider main girders or beams by adding more finger elements. Avoiding welding while assembling girder on-site, provides an advantage that no special tools or specialists are required to weld or inspect a welded joint.

The ultimate strength of the joint arrangement is high. If the friction capacity is exceeded, the joint arrangement will open but not fail completely as the shear capacity of the bolts is about 3-times higher than the friction capacity achieved by pretension. For the same reason broken threaded rods will not cause complete failing of the joint. Neither will fatigue damage in one finger element result in failing of the entire joint arrangement.

It is to be understood that the above description and the accompanying figures are only intended to illustrate the present invention. It will be obvious to a person skilled in the art that the invention can be varied and modified without de-parting from the scope of the invention.

1. A joint arrangement for connecting main girder parts, wherein the joint arrangement comprises
a first plurality of finger elements arranged on a first main girder part,
a second plurality of finger elements arranged on a second main girder part,
each finger element of the first plurality and the second plurality of finger elements comprises a top surface a bottom surface a first end and a second end,
wherein the first plurality of finger elements and the second plurality of finger elements are arranged to interconnect with each other, and
a first fastener arranged to rigidly lock the first plurality and the second plurality of finger elements together.

2. The joint arrangement as claimed in claim 1, wherein each finger element of the first plurality and the second plurality of finger elements is longitudinally parallel with each other.

3. The joint arrangement as claimed in claim 1, wherein at least one finger element of the first plurality of finger elements comprises at least one friction surface arranged to contact with a friction surface of the adjacent finger element of the second plurality of the finger elements.

4. The joint arrangement as claimed in claim 1, wherein at least one finger element of the first plurality and the second plurality of finger elements comprises a bevel at the first end and a rounded end at the second end.

5. The joint arrangement as claimed in claim 1, wherein at least one finger element of the first plurality and the second plurality of finger elements comprises an indentation at the bottom surface, said indentation forming a through-hole with the first main girder part or the second main girder part.

6. The joint arrangement as claimed in claim 1, wherein each finger of the first plurality and the second plurality of finger elements comprises a first aperture for accommodating the first fastener

7. The joint arrangement as claimed in claim 6, wherein each finger, of the first plurality and the second plurality of finger elements comprises a second aperture for accommodating a second fastener

8. The joint arrangement as claimed claim 1, wherein first ends of odd numbers of the finger element of the first plurality of finger elements are arranged longitudinally at a distance (D) away from first ends of even numbers of the finger elements of the first plurality of finger elements or first ends of odd numbers of the finger element of the second plurality of finger elements are longitudinally at a distance (D) away from first ends of even numbers of the finger elements of the second plurality of finger elements or both.

9. The joint arrangement as claimed in claim 1, wherein each finger element, of the first plurality and the second plurality of finger elements is substantially identical.

10. The joint arrangement as claimed in claim 1, wherein at least partially of the bottom surface of each finger element of the first plurality and the second plurality of finger elements is arranged to be welded to the respective first main girder part and the second main girder part.

11. The joint arrangement as claimed in claim 1, wherein at least one support plate is arranged on the top surface of the first plurality of finger elements and the second plurality of finger elements parallel with the first main girder part and second main girder part.

12. A method for connecting main girder parts, comprising:
101) providing a first plurality of finger elements and a second plurality of finger elements on a joint where a first main girder part and a second main girder part are to be connected, each finger element of the first plurality and the second plurality of finger elements comprising a top surface a bottom surface, a first end and a second end, and interconnecting the first and second plurality of finger elements with each other;
201) tightening the finger elements of the first plurality and the second plurality of finger elements together with a first fastener; and
301) welding the finger elements of the first plurality of the finger elements to the first main girder part, and welding the finger elements of the second plurality of finger elements to the second main girder part.

13. The method as claimed in claim 12, further comprising-after arranging first ends of odd numbers of the finger elements of the first plurality of finger elements at a distance (D) away from first ends of even numbers of the finger elements of the first plurality of finger elements, and arranging first ends of odd numbers of the finger elements of the second plurality of finger elements at the same distance (D) away from first ends of even numbers of the finger elements of the second plurality of finger elements after step 201).

14. The method as claimed in claim 12, wherein step 201) further comprises:
by 202) securing the finger elements, together through a first aperture of each finger elements, with the first fastener wherein the first aperture is arranged on a longitudinal centreline of the finger element and especially the first apertures of the even or odd numbers of the finger elements of the first plurality of finger elements further from the joint is located closest to the second end of the first plurality of finger elements.

15. The method as claimed in claim 13, wherein step 301) further comprises: by 302) rotating the even or odd numbers of the finger elements of the first plurality of finger elements further from the joint before welding the odd or even numbers of the finger elements of the first plurality of finger elements closest to the joint to the first main girder part, then rotating the even or odd numbers of the finger elements of the first plurality of finger elements further from the joint back and welding them to the first main girder part.

16. The method as claimed in claim 12, further comprising step 401) tightening the finger elements of the first plurality and the second plurality of finger elements together by securing the finger elements together through a second aperture of each finger elements with the second fastener, wherein at least one of the second apertures is located closest to the second end of the second plurality of finger elements.

17. The method as claimed in claim 16, further comprising: 501) releasing the first fastener from each first aperture of the finger elements while the second fastener is fastened via each second aperture of the finger elements.

18. The method as claimed in claim 12, further comprising:
801) providing a first support plate on top of the first plurality of finger elements, parallel with the first main girder part, and welding said first support plate to the top surface of at least one finger element of the first plurality of finger elements.
